(19) United States
(12) Patent Application Publication
(10) Pub. No.: US 2016/0047215 A1
(43) Pub. Date: Feb. 18, 2016

(54) Real Time and Playback Interpretation of Fracturing Pressure Data

(71) Applicant: Petro Research and Analysis Corp, Lubbock, TX (US)

(72) Inventors: Mohamed Yousef Soliman, Cypress, TX (US); Elias Pirayesh, Lubbock, TX (US); Mehdi Rafiee, Houston, TX (US)

(73) Assignee: PETRO RESEARCH AND ANALYSIS CORP, Lubbock, TX (US)

(21) Appl. No.: 14/461,429

(22) Filed: Aug. 17, 2014

(51) Int. Cl. E21B 43/26; E21B 43/267; G01V 1/30; E21B 47/00

(52) U.S. Cl. CPC E21B 43/26; E21B 47/00; E21B 43/267; G01V 1/306

(57) ABSTRACT

The invention provides methods for performing the appropriate manipulation of pressure-time data during a hydraulic fracturing treatment or test to determine the condition of the created fracture. The mode of growth, dilation, or intersection with one or more natural fractures may be determined accurately and quickly. The methods include the steps of acquiring fracturing data, assessing the fracturing index based on a moving reference point, and establishing the mode of fracture propagation using the fracturing index. The methods provide for the determination of the time of intersection of a hydraulic fractures with one or more natural fractures. The methods also provide for an early warning of sand-out possibility. The data analysis may be performed in real time during the progress of the treatment or test or in a playback mode after the completion of the treatment or test.

### CROSS-REFERENCE TO RELATED APPLICATIONS

None.

### BACKGROUND OF THE INVENTION

1. Field of Invention

This invention is related to performing hydraulic fracturing process on a well, and interpreting its performance as the fracturing process progresses, thus deciding whether to continue the process as planned, or to modify some of the parameters such as sand (proppant) concentration, type, or viscosity of the injected fluid as the fracturing treatment is injected.

2. Setting of the Invention

Hydrocarbon production from a reservoir depends on the physical and mechanical properties of the rock and properties of the reservoir fluid. If the reservoir is of poor quality or low pressure and incapable of delivering the desired flow rates, change of reservoir conditions at the wellbore would help achieving the desired flow rate. Hydraulic fracturing is generally the best way to achieve that goal. Hydraulic fracturing creates a high permeability narrow path deep into the formation. Under this condition, the formation hydrocarbon would flow into the hydraulic fracture and then through the hydraulic fracture into the wellbore. In other words hydraulic fracturing changes the flow path (regime) of fluids inside the reservoir. The formation is fractured by injecting fluid at high enough rate and pressure to cause a tensile fracture from the wellbore and deep into the formation. The continuous injection of fluid into the wellbore causes the fracture to propagate further into the formation. It is usually desired have long high conductivity fracture that does not significantly propagate in height for fear of fracturing into undesirable formations such as water-carrying formations. It is also desirable to monitor and analyze the fracture treatment response as it takes place to make sure that the treatment is terminated prior to sand out to make sure that the wellbore is not left with excessive amount of sand that would require costly cleanup. Thus the ability to monitor a fracturing treatment progress and to quickly make a reliable decision is important. It is also desirable to analyze the fracturing in a playback mode to learn more of what happened during the treatment in order to more efficiently design future fractures.

### SUMMARY OF THE INVENTION

In this invention a fracture is initiated and the fracturing pressuring is monitored. Downhole pressure is probably preferred; however surface pressure with adequate friction correlation would be appropriate. The observed pressure is plotted using the moving reference point technique described in the body of the patent and also presented by Pirayesh, et al and Soliman et al. Depending on the calculated propagation exponent, which will be referred to fracturing index, a decision is made regarding the state of the fracture. The basic assumption here is that a fracture does not propagate continuously but rather intermittently. Each of those intermittent propagation periods may still be approximated by the power law concept and the identification of the various modes of propagation is crucial.

### BRIEF DESCRIPTION OF THE DRAWING

FIG. 1 is a drawing of the net fracturing pressure versus time in log-log scale.

FIG. 2 is a flow chart of the proposed new technique

FIG. 3 is the bottom hole pressure versus time for example 1

FIG. 4 is a drawing of the net pressure versus time as per Nolte-Smith Technique for example 1

FIG. 5 is a drawing of the fracturing index, e, versus time of example 1

FIG. 6 is summary of analysis comparison between the Original Nolte-Smith analysis and the new technique for example 1

FIG. 7 is a drawing of the pressure, slurry injection rate and sand concentration versus time for example 2

FIG. 8 is a drawing of the net pressure versus time as per Nolte-Smith Technique for example 2

FIG. 9 is a drawing of the fracturing index, e, versus time of example 2

FIG. 10 is a drawing of the fracturing index, e, versus time of example 3 (Shale Example)

### DETAILED DESCRIPTION OF THE INVENTION

Using the fracture propagation model developed by Perkins and Kern (1961) and refined by Nordgren (1972), the fracturing pressure at the wellbore may be written as a power function of time as given in equation 1.

$${p}_{net} α {t}^{e} , \frac{1}{8} \leq e \leq \frac{1}{5} \qquad 1$$

A large exponent is an indication of low leak-off rate. In other words, more fluid is maintained inside the fracture and contributes to fracture propagation. The bounds given in equation 1 are based on a Newtonian fluid, which was generalized, by Nolte (1979) to the following form:

$$\frac{1}{4 n + 4} \leq e \leq \frac{1}{2 n + 3} \qquad 1$$

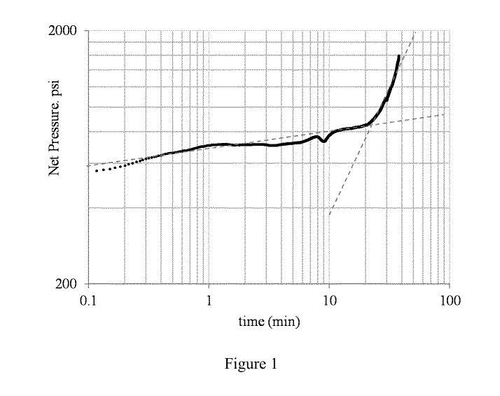

Using dimensional analysis, Nolte and Smith (1981) reached the conclusion that there are four modes of fracture propagation. Beginning with the start of the fracturing treatment, each of those modes is defined by a specific slope on a plot of log of pₙₑₜ vs. log of time. Four basic modes were described by Nolte and smith 1) a mode where a small positive slope on the log-log plot is observed and indicates that the fracture is propagating normally and 2) a mode where a unit slope on the log-log plot is observed and identified to mean a screen-out mode (FIG. 1). 3) a mode when pressure drops rapidly and is usually the sign of uncontained fracture height growth or more accurately increase in area available for leak-off, and 4) an elongated flat pressure for which there may be multiple explanations. Based on the succeeding pressure trend, several interpretations are possible for the modes 3 and 4, which include rapid height growth, increasing fracture compliance, and opening of fissures.

In addition to the basic assumptions as noted by Nolte and Smith (1981), the analysis has two additional implied assumptions. The first assumption is that the injection rate is constant. The second assumption is that the fracture propagation is continuous (smooth function of time). Furthermore, to ensure correct interpretation of fracturing events, Nolte-Smith analysis necessitates precise knowledge of formation closure pressure. This requires conducting of pre-fracturing tests, such as minifrac tests, that are not routinely performed in every fracturing job. This issue is furthered with the increasing application of multi-stage multi-cluster fracturing schemes where the subsequent fracturing stages experience higher ISIP's and thus higher closure stresses (Mayerhofer et al., 2011; Soliman et al., 2008).

### New Approach

This approach builds on the work of Nolte and Smith by coupling the fracture propagation theory to basic testing technology. The original Nolte-Smith analysis assumes that the fracture continuously and smoothly propagates with time. Some of the recent field observations through microseismic monitoring, especially in fractured shale formations, imply that a fracture may be growing intermittently. This sporadic fracture growth implies that a fracture might go through periods of dilation, growth, high leak-off. Identifying those various modes accurately throughout the fracture treatment will help in diagnosing problems and identifying potential sand out very early, or intersection of natural fracture swarms. The hypothesis is that a fracture may go through multiple periods of fracture propagation, dilation or high rate of leak off.

In the original Nolte-smith technique the analysis has a reference point which is the start of the fracturing treatment. The analysis technique developed by Nolte-Smith and its underlying assumption of continuous, smooth propagation hinders the accurate identification of events occurring during the fracturing.

In the new approach, the reference point is not set at the start of injection, but rather the start of a growth, dilation, or natural fracture dilation period which may occur multiple times during a fracturing treatment. In other words the reference point changes every time mode of fracture propagation changes. This change in the reference point yields accurate interpretation of the fracture propagation behavior and better and faster identification of potential problems.

### Development of Governing Equations

The basic Nolte-Smith technique depends on the power law equation for propagation of a hydraulic fracture given below as equation 3.

log(p−p_{closure})αe log(t) 2

Nolte-Smith technique assumes that the fracture passes through various phases and each phase is continuous. Thus, it assumes that the log-log plot of the net pressure versus time should yield a straight line with slope e. The value of the slope e (fracturing index) depends on the fracturing fluid flow-behavior-index, n. It has been observed that the assumption of continuous propagation, although sometime helpful, may not be always accurate. As noted above, fracture propagation may consist of periods of dilation followed by periods of growth. These periods of dilation (sometimes referred to as ballooning) and growth may alternate through the injection period. Identifying of periods of spurt growth may be very helpful and is described in the following analysis.

Assuming that the reference point is tᵢ, equation 4 is the general power law equation of fracture growth. In Nolte-Smith Analysis the reference point, tᵢ is set as zero. In this analysis, this reference time is the start of a growth period. As shown below equations 5 and 6 may be derived from equation 4.

$$\begin{matrix}p - {p}_{i} = {C ( t - {t}_{i} )}^{e} & 3 \\ \frac{\partial p}{\partial t} = {eC ( t - {t}_{i} )}^{e - 1} & 4 \\ ( t - {t}_{i} ) \frac{\partial p}{\partial t} = {eC ( t - {t}_{i} )}^{e} & 5\end{matrix}$$

Taking the logarithm of equations 4-6, we get equations 7-9.

$$\begin{matrix}log ( p - {p}_{i} ) = log ( C ) + e log ( t - {t}_{i} ) & 6 \\ log ( \frac{\partial p}{\partial t} ) = log ( eC ) + ( e - 1 ) log ( t - {t}_{i} ) & 7 \\ log [ ( t - {t}_{i} ) \frac{\partial p}{\partial t} ] = log ( eC ) + e log ( t - {t}_{i} ) & 8\end{matrix}$$

Equations 4 and 6 may be combined to yield the following equation:

$$( t - {t}_{i} ) \frac{\partial p}{\partial t} = e ( p - {p}_{i} ) \qquad 9$$

If the fracture is propagating then the fracturing index, e, will generally have a value of range determined using equation 2, the value of e will usually being ≈0.25. If the fracture is dilating, the fracturing index will be 1, similar to what one would observe in any storage situation. In the case of fracture dilating, equation 10 becomes equation 11.

$$( t - {t}_{i} ) \frac{\partial p}{\partial t} = p ( t ) \qquad 10$$

Equations 4-6 take the following format:

$$\begin{matrix}p - {p}_{i} = C ( t - {t}_{i} ) & 11 \\ \frac{\partial p}{\partial t} = C & 12 \\ ( t - {t}_{i} ) \frac{\partial p}{\partial t} = C ( t - {t}_{i} ) & 13\end{matrix}$$

### Numerical Procedure

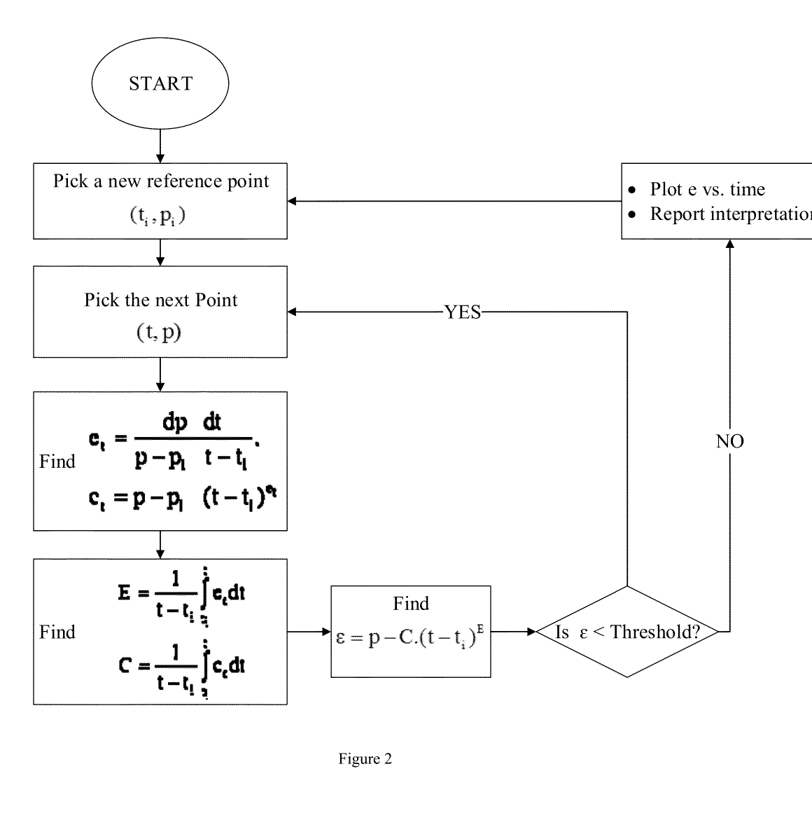

Analysis of fracturing pressure with the new technique is performed according to the data analysis flow chart presented in FIG. 2. To begin the analysis, an initial reference point (t_{ref}, p_{ref}), which meets the following criteria is picked:
I. For intact formations, the first reference point must be picked after the formation breakdown has occurred.
II. For formations with existing flaws such as small cracks resulting from MiniFrac tests, the first reference point can be picked at any time after the existing crack has been reopened. The sandstone formation of example 1 which has been previously subject to MiniFrac and step-rate tests falls into this category.

To obtain meaningful results, it is recommended that the first few points of pressure data be omitted from analysis as such data usually contain severe fluctuations and are usually affected by formation breakdown/fracture re-opening. After having picked the reference point, analysis continues by selecting (t,p) pairs and then by calculating e using equation 10. Values of e are then plotted vs. time and used for fracturing behavior interpretation. In every time step, an average E and C are also calculated using equations 15a and 15b, respectively. E and C are subsequently used to estimate BHP_{est.} (equation 16).

$$\begin{matrix}E = \frac{1}{t - {t}_{i}} {\int }_{{t}_{i}}^{t} {e}_{t} d t ( a ) \\ C = \frac{1}{t - {t}_{i}} {\int }_{{t}_{i}}^{t} {c}_{t} d t ( b ) & 15 \\ {BHP}_{est .} = {p}_{ref} + C \cdot {( t - {t}_{ref} )}^{E} & 14\end{matrix}$$

If the difference between the BHP_{est.} calculated using equation 16 and the observed bottom-hole pressure i.e. p(t) exceeds a pre-determined threshold, then the next point in time is chosen as the new reference point. In this way, the entire process is repeated until injection stops.

### Application to Homogeneous Formations

If the formation is perfectly homogeneous and isotropic, the fracture growth may be continuous and the slope of the net pressure with time may follow the theory developed by Nolte and Smith (1981). As mentioned already this ideal behavior is not expected to happen in real reservoirs. Application of this new technique in the fracturing pressure analysis of two FracPack examples will be provided in the subsequent sections and will show the intermittent nature of fracture propagation.

### Application to Heterogeneous Formations

If the formation contains various heterogeneity, natural fractures, and planes of weaknesses, it is expected that the fracture growth would consist of periods of propagation and natural fracture opening. Basically, the hydraulic fracture propagates following the established theory until its tip intersects a region of heterogeneity. Once the hydraulic fracture reaches the region of heterogeneity (swarms of natural fracture) the fracturing fluid may open the natural fracture. This may cause temporary decline in pressure which would be interpreted as increase in leak-off area. Once the natural fractures are sufficiently dilated, the main hydraulic fracture may resume propagation. During this dilating period, the fracture volume is expected to increase. The dilating effect is similar to the tip screen out effect discussed by Nolte and Smith characterized by sharp increase in pressure. However it is of fairly short duration. This effect would very difficult or even impossible to see using the original Nolte-Smith technique. The volume of the hydraulic fracture and natural fracture may be calculated using the following equation.

$$\frac{\partial p}{\partial t} = \frac{0.041665}{{C}_{ff} {V}_{f}} \qquad 15$$

Equation 17 is easily derived from basic well testing equation for storage period. One may also use the equation developed by Nolte and Smith, which is based on the compliance of the fracture.

$$\frac{\partial p}{\partial t} = \frac{2 ( {q}_{i} - {q}_{1} ) {E}^{′}}{π {h}^{2} L} \qquad 16$$

### Where

$${E}^{′} = \frac{E}{1 - {υ}^{2}} \qquad 19$$

As Nolte and Smith (1981) have suggested, equation 18 may be used to estimate the distance to the restriction and consequently determining whether the restriction is due to tip screen out or near wellbore restriction. Equation 17 may be used in the same fashion to determine the distance to obstruction. Calculating the volume of the fracture using equation 17 at different times during the process of creating the fracture may be taken as a measure of fracture complexity.

### Measuring Downhole Pressure

It is recommended that a downhole gauge with surface read-out be used to monitor pressure changes during the analysis and this may give more accurate representation of the growth and dilation periods. Surface pressure gauges may be used in the analysis; however, it would be preferable to use downhole pressure measurement. In the first group of cases that were analyzed in this study surface pressure was used, which is acceptable since the proppant concentration was fairly low. Downhole pressure was available for use in the second group of cases. In general, the use of surface pressure is acceptable as long as satisfactory correlations exist, and no the changes in fluid properties and proppant concentration are not oscillating widely. It is usually expected to see constant or fairly small variation in fluid properties and sand concentration. The combined use of real-time interpretation using this new technique in conjunction with other monitoring techniques such as microseismic may improve the efficiency of the fracturing process. This combined use of various technologies leads to better decision making during the treatment or in the post-mortem analysis and evaluation.

### EXAMPLES

Application of the new technique is illustrated through several examples. The four fracturing modes introduced by Nolte and Smith (1981) are used with the propagation index, e, is plotted versus time to monitor the behavior of fractures during pumping. Values of e in the range of

$$\frac{1}{4 n + 4} \leq e \leq \frac{1}{2 n + 3}$$

indicate that the created fracture is propagating under the assumptions of Perkins and Kem (1981), which are confined height, constant fracture compliance, and unrestricted extension. e≈1 Usually means that fracture propagation has decreased significantly and instead fluid storage is taking place in the form of increasing fracture average pressure and average width. In addition, a rapid pressure drop i.e. e<<0 is the sign of rapid height growth. More than one explanation exists for a constant fracturing pressure trend (i.e. e≈0). Usually the explanation is based on the succeeding pressure behavior.

### Example 1

### High Perm Oil Well FracPack

Frac packs are normally high-rate treatments designed to create a highly conductive fracture to bypass the skin damage in high permeability formations. Due to high rates of injection, full packing of fractures may start and lead to pressures much beyond the allowable levels in a matter of minutes. Therefore quick identification of the onset of fracture-packing is of utmost importance to prevent both intolerable pressure levels and over-flushing of proppants. Numerical simulators have been used to match fracturing pressure data, however fracturing simulators are not fully capable of replicating fracturing behavior in real time. Two frac pack examples are presented here to illustrate how the new analysis technique may be used in different geologies to obtain a more detailed understanding of fracture behavior as well as to accelerate identification of fracturing problems. The two frac packs are vastly different from each other in size and in their subjected geologies. With an injected volume of 37K gallons of slurry, the first treatment is almost twice the size of the second one, which injected 21,000 gallons of slurry. Also the first treatment was done in a relatively thin sandstone which was only 40 ft. in height whereas the second one pumped into 215 ft. of perforated interval spanning through several layers of high perm sandstone and also shale and silty sand. Results of fracture analysis studies with a three-dimensional fracturing simulator indicate that the first treatment creates a fracture with a length-to-height-ratio of about 4.65, a suitable PKN-type

### Job Design

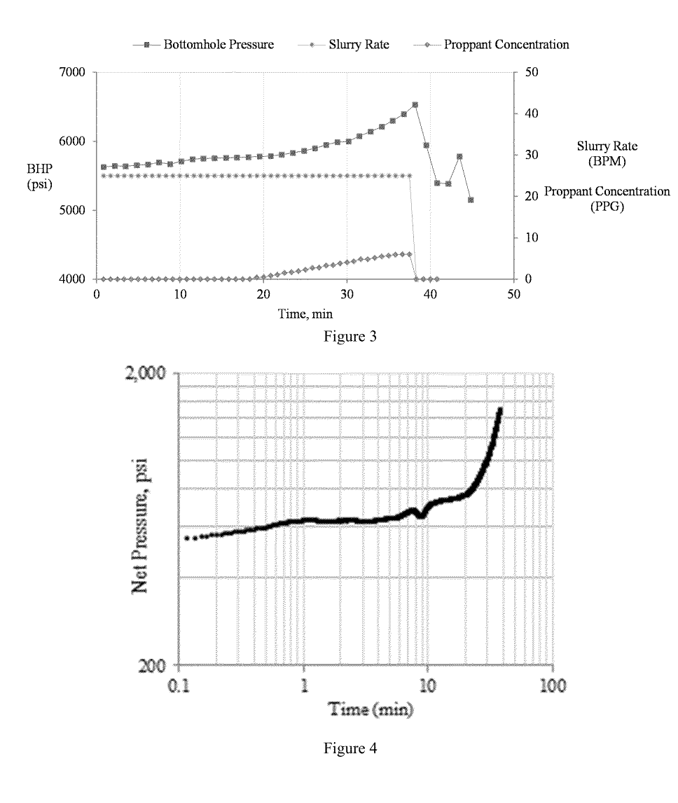

A FracPack given in FIG. 3 performed in a high perm sandstone formation pumped 37,000 gallons of a 25 lb seawater-based fracturing fluid and 54,000 pounds of a 12/18 light weight synthetic proppant. While a constant slurry injection rate of 25 BPM was maintained throughout the treatment, proppant injection started at t=8.4 min and continued till the end of the treatment when the fracture could be packed no more. Minifrac test results show that the sandstone formation which has an average closure stress of 5,022 psi, 200-250 psi lower than the surrounding shale barrier. This along with a modouli of elasticity in the order of the modouli of the surrounding shale and a relatively small fracture toughness are expected to lead to confined height fracture growth. The fracturing fluid has a flow behavior index of 0.5 for which the fracture propagation or mode I slope ranges from ⅙ to ⅕.

### Analysis Using Conventional Nolte-Smith Technique

The log-log plot of Pₙₑₜ vs. time of examples 1 (FIG. 4) matches case 2 of Nolte-Smith (1981) and is comprised of two distinct periods, including
t<20 min: The slope of this period matches that of mode I, and thus indicates that fracture propagation is the predominant event of this period.
t≧20 min: With a slope of 1 or higher, this period fits the definition of mode III. The most possible interpretation of which is dilation of the fracture with little or fracture propagation in length. For this specific example, this barrier if full-packing of fracture by the injected proppants.

In summary, fracturing modes I and III were identified on the Nolte-Smith chart of example 1 which helped determine the onset of fracture packing at about 30 min or even longer.

### New Technique

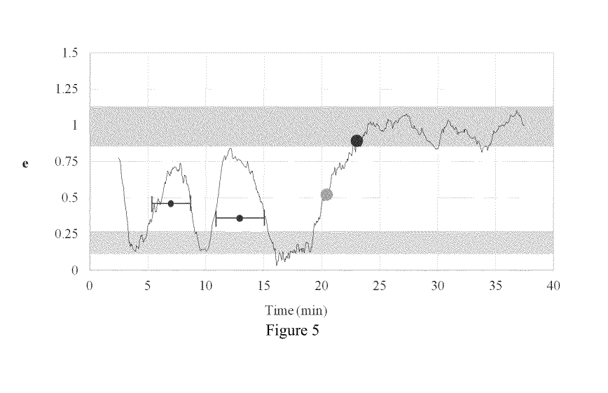

As shown in FIG. 5, the new analysis confirms the results achieved by Nolte-Smith technique, meaning that a period of overall fracture propagation i.e., ⅙ to ⅕ (on the e-time plots, this range will be highlighted in green) is followed by a period during which continued fluid storage resulting from sand injection seems to be the predominant event (on the e-time plots, this range will be highlighted in red). FIG. 5 also shows that from time zero to t=20 min, the created fracture has gone through periods of dilating and growth. Marked by [symbol] signs on FIG. 5, periods of dilating have formed two peaks reaching almost into the red zone. It is well accepted that quick detection of the beginning of fracture packing and screenouts is very significant in fracturing treatments, especially in FracPacks. For the example in hand, the response of the new analysis technique to fracture dilation period starts as early as t=21 min (marked by an orange circle on FIG. 5) when the curvature of the plot changes from positive to negative or by t=23 min (marked by a red circle on FIG. 5) when the plot has fallen well within the red zone.

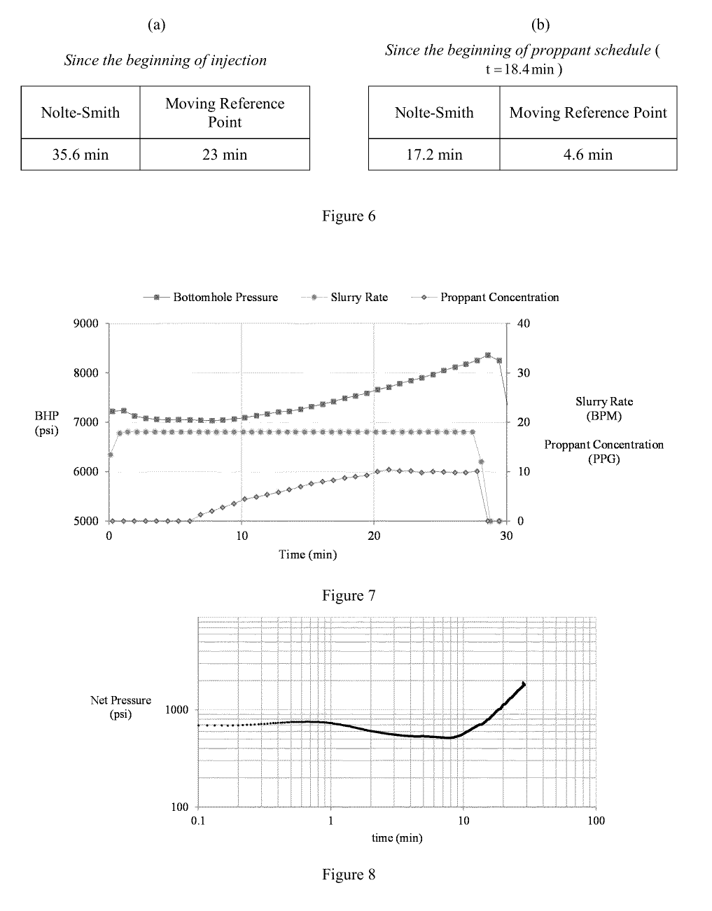

Application of Nolte-Smith analysis in real time is such that after observing a unit slope line on the Nolte-Smith chart, fracturing engineer needs to wait at least quarter of a log cycle (of time) to confirm fracturing mode III. In case of example 1, this necessary precaution will delay recognition of fracture packing till t=35.6 min. FIG. 6 which compares the FracPacking identification times of Nolte-Smith versus the new technique, shows that the new technique identified the impending sand-out in about ¼ of the time taken by Nolte-Smith to detect the onset of fluid storage resulting from the introduction of proppants into the fracture.

In summary, use of the new technique in the analysis of fracturing pressure gives a much more accurate description of fracture behavior during pumping. In addition, it permits almost instantaneous identification of fracturing problems such as screenouts. In case of example 1, a comparison made of Nolte-Smith original approach versus the new technique showed that the new analysis technique cuts problem recognition time by a factor of about 4. This quick identification of this impending sand-out leaves ample time for operator to react.

### Example 2

### High Perm Gas Well FracPack—Job Design

A FracPack treatment performed in a high permeability sandstone formation (FIG. 7) used 21,000 gallons of a 25#seawater-based fracturing fluid and 90,600 pounds of a 12/18 light weight synthetic proppant. A constant injection rate of 18 BPM was maintained throughout the treatment and the proppant was injected in a ramped manner. Bound by two thick shale layers, the pay zone consists of two high leakoff sandstone layers separated from each other by several layers of shale and silty sand. As confirmed by a minifrac test, the closure stress of the pay zone is about 6,500 psi which is substantially lower than the closure stresses of the bounding shale formations. The fracturing fluid here is the same as example 1 and thus fracturing mode I (i.e. PKN-type propagation) is expected to happen in the same condition as was discussed before i.e. Nolte-Smith slopes ranging from ⅙ to ⅕.

### Analysis

On the log-log plot of pₙₑₜ vs. time of this example (FIG. 8), three distinct periods may be identified:
t<1 min: Pressure grows with a small slope of 0.1 and so the major fracking event of this short period is PKN-type fracture propagation.
1 min<t<3 min and 3 min<t<9 min: With a slope of about −0.35 and −0.1, respectively, these periods meet the conditions of mode IV i.e. fracture height growth.
t>10 min: During this period, pressure increases with a slope larger than unity, which indicates blockage of fluid flow paths by the injected proppants.

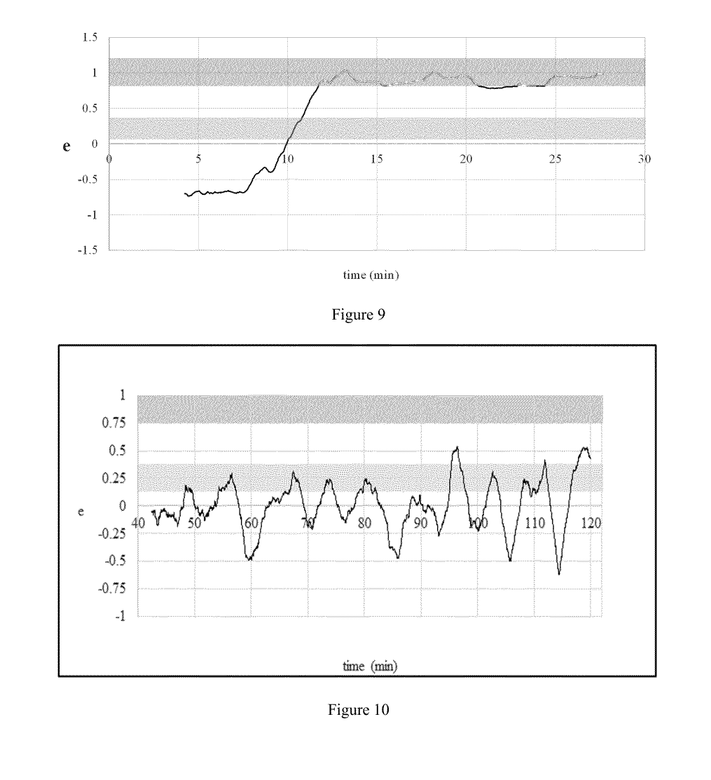

As shown in FIG. 9, results of analysis with the new technique agree with the findings of Nolte-Smith technique, meaning that an elongated period with an average e of about −0.70 prevails through the first 10 minutes of injection. This period of major fracture height growth is followed by a prolonged period of fracture dilation with an e of about 1 which lasts till the end of injection. These interpretations are in accordance with the results of our fracturing simulation study which gave a good match with the observed net pressure. The created fracture using design simulator has a length-to-height ratio of about 0.75, proving the predominance of height growth during the first 9 minutes of injection. It also shows that the fracture profile has remained almost constant from t≈9 min till the end of the FracPack. It also shows that the major event during this period is fracture dilation in the form of rapid increase in pressure and fracture width.

### Example 3

### Shale Formation Job Design

This example is from a fracturing treatment performed in a horizontal well in the Eagle Ford shale. The Eagle Ford shale produces both gas and high-gravity oil and is mainly a clay-rich limestone with very low quartz content. This tends to make it less brittle (more ductile) with a low Young's Modulus (E) of ˜2×10E6 psi. Testing on the Eagle Ford shale cores indicates that because the rock is relatively soft (low E), it is prone to proppant embedment. It is also highly naturally fractured. Several fracturing treatments have been analyzed and all have shown similar behavior that is demonstrated in in FIG. 10. The figure indicates that main fracture had intercepted several major natural fractures that were opened. Each time the fracturing index dipped to a negative value is an indication of opening a major natural fracture. The recovery of fracturing index to the positive territory indicates that the fracture resumed propagation after packing the natural fracture with proppant.

### SUMMARY

The FracPack and shale examples provided above demonstrate that the new analysis technique offers a better view and interpretation of what happens in real reservoirs. The examples illustrate that fractures grow intermittently and the new analysis technique provides a method to diagnose fracturing treatment in a way that would not have been possible with existing techniques. This enhanced understanding lead to verification of some field observations such as growth of fractures in intermittently and also penetration of fractures into separated shale layers. Field data analyzed using the new technique would yield fracturing events that would go unnoticed by Nolte-Smith technique.

### Limits of Fracturing Index

In general, the calculated fracturing index indicates the mode of fracture propagation. A fracturing index of 1 indicates a dilating mode. A fracturing index of about 0.20-0.25 means propagation normally. It would be expected that the fracturing index would vary as given in the examples between those two values. A negative fracturing index indicates fairly fast fracture height growth. Persistent fracturing index of 1 indicates start of sand out. In case of shale formations, it is expected that the fracturing index will reach a negative value when it opens up a natural fracture. Once the hydraulic fracture resumes propagation, the fracturing index should go back to the range consistent with fracture propagation. Linking the observation with a fracture design simulator and or micro-seismic monitoring, it is possible to calculate the distance to the natural fractures and the volume of those natural fractures.

### Linkage to Other Processes

The method described in this patent may be linked with evaluation of the fracture propagation through a fracture design simulator to calculate the distance to the various events during the progress of the hydraulic fracturing process. This method may be also linked with the monitoring of seismic events of the fracture propagation to determine the distance and location of the various events during the progress of the hydraulic fracturing process. This linkage may be done in real time or subsequent to the treatment in a playback mode for further evaluation of the treatment and/or prediction of well and reservoir production. The analysis technique would also enable the analyst to apply additional intervention techniques at the appropriate time.

The description of the terms used in the patent given herein.
C Constant
C_{ff} Fracturing fluid compressibility, psi⁻¹
e Fracturing index
E Young's modulus
E′ Plain strain Young's modulus
K_{IC} Fracture toughness, psi·in^{1/2}
L Fracture length (tip to tip), ft
n Flow behavior index
p Net pressure, psi
p_{cl} closure stress, psi
qᵢ injection rate into one wing of the fracture, ft³/min
qᵢ Leak-off rate of one wing of the fracture, ft³/min
t Time, min
tᵢ Time of start of a new period, min
V_{f} Fracture volume, ft³
u Poisson's ratio

### REFERENCES CITED

Mayerhofer, Michael J, Stegent, Neil Alan, Barth, James O, & Ryan, Kevin M. (2011). Integrating Fracture Diagnostics and Engineering Data in the Marcellus Shale. Paper SPE 145463 presented at the SPE Annual Technical Conference and Exhibition, Denver, Colo., USA, 30 October-2 November. http://dx.doi.org/10.2118/145463-ms.
Nolte, K. G. (1979). Determination of Fracture Parameters from Fracturing Pressure Decline. Paper SPE 8341 presented at the SPE Annual Technical Conference and Exhibition, Las Vegas, Nev., 23-26 September. http://dx.doi.org/10.2118/8341-ms.
Nolte, K. G., & Smith, M B. (1981). Interpretation of Fracturing Pressures. Journal of Petroleum Technology, 33(9): 1767-1775. SPE 8297. http://dx.doi.org/10.2118/8297-PA.
Nordgren, R. P. (1972). Propagation of a Vertical Hydraulic Fracture. Society of Petroleum Engineers Journal, 12(4): 306-314. SPE 3009. http://dx.doi.org/10.2118/3009-pa.
Perkins, T. K., & Kem, L. R. (1961). Widths of Hydraulic Fractures. Journal of Petroleum Technology, 13(9): 937-949. SPE 89. http://dx.doi.org/10.2118/89-pa.
Pirayesh, Elias, Soliman, Mohamed Y., & Rafiee, Mehdi. (2013). Make Decision on the Fly: A New Method to Interpret Pressure-Time Data during Fracturing—Application to Frac Pack. Paper SPE 166132 presented at the SPE Annual Technical Conference and Exhibition, New Orleans, 30 September-2 October.
Soliman, M. Y., East, Loyd, & Adams, David. (2008). Geomechanics Aspects of Multiple Fracturing of Horizontal and Vertical Wells. SPE Drilling & Completion, 23(3): 217-228. SPE 86992. http://dx.doi.org/10.2118/86992-pa.
Soliman, M. Y, Wigwe, A. Alzahabi, E. Pirayesh, N. Stegent. 2014. Analysis of Fracturing Pressure Data in Heterogeneous Shale Formations. Volume 1-Number 2, Hydraulic Fracturing Journal, April 2014, pp 8-13

1. A real-time fracturing pressure response analysis system, the system comprising
one or more processors;
an input/output unit in communication with the one or more processors;
one or more electronic interfaces set up to display a report of fracture analysis and a report of possible reactions to continued fracture treatment injection or change in fracturing operation; and
a non-transitory computer-readable medium positioned in communication with the one or more processors and containing one or more computer programs instructing one or more processors to perform operations of:
producing the fracture analysis interface to display to a user thereof one or more real-time fracture analysis reports;
calculating, by one or more processors, the fracturing index and its variation with time and output; and
outputting to one or more electronic interfaces, which are arranged to display a real-time fracture analysis report for a reservoir, the report establishing fracture propagation behavior and including an evaluation of projected fracture propagation.

2. The process of claim 1, wherein the fracture propagation is hypothesized to propagate intermittently.

3. The process of claim 1, wherein the fracturing index determines mode of propagation.

4. The process of claim 1, wherein the fracturing index is calculated using a time window that is based on a reference point.

5. The process of claim 1, wherein said reference point remains the basis for calculation of the fracturing index as long as the mode of propagation does not change.

6. The process of claim 1, wherein the event of a change of mode of propagation, the reference point of the fracturing index is moved to a new position corresponding to said change of mode of propagation.

7. The process of claim 1, wherein the fracturing index approaching a value of 1.0 indicates start of sand-out (screen out).

8. The process of claim 1, wherein, in the case of sand out mode, shifting to proppant-free-slurry and shutting down treatment after slurry reaches sand-face leaves well free of proppant.

9. The process of claim 1, wherein a remedial action may be taken on the basis of the fracturing index and duration of the fracturing mode in order to obtain a better fracturing treatment.

10. The process of claim 1, wherein use of downhole mixing tools provides real-time or near real-time response in order to delay sandout and to leave well clean of proppant.

11. The process of claim 1, wherein an alternation of the fracturing index from about 0.25 to about −0.5 indicates an intersection of created fracture with one or more natural fractures.

12. The process of claim 1, wherein a change in fracturing pressure combined with an increase in slurry proppant concentration or rate causes a further opening of one or more natural fractures.

13. The process of claim 1, wherein the fracture treatment injection is prolonged in order for the created fracture to further intersect one or more natural fractures.

14. The process of claim 1, wherein an interpretation of the fracturing data is combined with micro-seismic analysis to determine distance of observed events.

15. The process of claim 1, wherein an interpretation of the fracturing data is combined with fracture simulation design to determine distance of observed events.

16. A fracturing pressure response analysis system of previously collected fracturing data, the system comprising
one or more processors;
an input/output unit in communication with the one or more processors;
one or more electronic interfaces set up to display the fracture analysis report; and
a non-transitory computer-readable medium placed in communication with the one or more processors and containing one or more computer programs instructing one or more processors to perform operations of:
producing the fracture analysis interface to display to a user thereof one or more fracture analysis reports;
calculating, with one or more processors, the fracturing index and its variation with time and output;
outputting to one or more electronic interfaces which are arranged to display a fracture analysis report for a reservoir, the report establishing fracture propagation behavior and including an evaluation of collected fracturing data.

17. The process of claim 16, wherein the fracture propagation is hypothesized to propagate intermittently.

18. The process of claim 16, wherein the fracturing index determines mode of propagation.

19. The process of claim 16, wherein the fracturing index is calculated using a time window that is based on a reference point.

20. The process of claim 16, wherein said reference point remains the basis for calculation of the fracturing index as long as the mode of propagation does not change.

21. The process of claim 16, wherein in the event of a change of mode of propagation, the reference point of the fracturing index is moved to a new position corresponding to said change of mode of propagation.

22. The process of claim 16, wherein a fracturing index approaching a value of 1.0 indicates start of sand-out (screen out).

23. The process of claim 16, wherein an alternation of the fracturing index from about 0.25 to about −0.5 indicates an intersection with one or more natural fractures.

24. The process of claim 16, wherein an interpretation of the fracturing data is combined with micro-seismic analysis to determine distance of observed events.

25. The process of claim 16, wherein an interpretation of the fracturing data is combined with fracture simulation design to determine distance of observed events.
